(19) United States
(12) Patent Application Publication
(10) Pub. No.: US 2019/0321884 A1
(43) Pub. Date: Oct. 24, 2019

(54) FLUID COMPOSITION FOR THREE-DIMENSIONAL SHAPING, MANUFACTURING METHOD FOR THREE-DIMENSIONALLY SHAPED OBJECT, AND THREE-DIMENSIONALLY SHAPED OBJECT

(71) Applicant: Seiko Epson Corporation, Tokyo (JP)

(72) Inventor: Naoko SHIMA, Shiojiri (JP)

(21) Appl. No.: 16/390,101

(22) Filed: Apr. 22, 2019

(30) Foreign Application Priority Data
Apr. 23, 2018 (JP) 2018-082312

(51) Int. Cl. B22F 3/10; C08L 5/08; C08L 1/02; B22F 3/105; B22F 1/00; B22F 3/20

(52) U.S. Cl. CPC B22F 3/1035; B22F 2999/00; C08L 1/02; B22F 3/1055; B22F 1/0011; B22F 3/20; C08L 2203/12; B22F 2003/1057; B22F 2301/10; B22F 2301/35; B22F 2301/15; B22F 2302/253; B22F 2302/256; B22F 2302/45; C08L 5/08

(57) ABSTRACT

Provided is a fluid composition for three-dimensional shaping used for manufacturing a three-dimensionally shaped object, and contains constituent material particles formed from metal and constituting the three-dimensionally shaped object and nanofiber containing at least one of chitosan nanofiber and cellulose nanofiber. By using such a fluid composition for three-dimensional shaping, the ejectability for manufacturing the three-dimensionally shaped object can be improved, and sediment of the constituent materials can be suppressed.

The present application is based on, and claims priority from JP Application Serial Number 2018-082312, filed Apr. 23, 2018, the disclosure of which is hereby incorporated by reference herein in its entirety.

### BACKGROUND

### 1. Technical Field

The present disclosure relates to a fluid composition for three-dimensional shaping, to a manufacturing method for a three-dimensionally shaped object, and to a three-dimensionally shaped object.

### 2. Related Art

Three-dimensionally shaped objects have been manufactured from various materials, and various fluid compositions for three-dimensional shaping have been used for manufacturing the three-dimensionally shaped objects. Among these, a fluid composition for three-dimensional shaping containing metal particles as constituent material particles is used for a three-dimensionally shaped object formed from metal.

For example, JP-A-2008-184622 discloses a method for manufacturing a three-dimensionally shaped object by using a metal paste (fluid composition for three-dimensional shaping) containing metal powder serving as constituent material particles, a solvent, and an adhesion promoting agent.

When manufacturing a three-dimensionally shaped object by using a fluid composition for three-dimensional shaping, for example, it is required that the fluid composition has desired physical properties (e.g. dynamic viscosity) because the fluid composition for three-dimensional shaping is to be ejected. Meanwhile, it is required that constituent material particles are not likely to sediment, for example, when the fluid composition for three-dimensional shaping is left to stand. Further, it is required that components other than the constituent material particles are reduced as much as possible to suppress degradation of performance (e.g. degradation of rigidity) of the three-dimensionally shaped object to be manufactured.

However, in such a fluid composition for three-dimensional shaping as one disclosed in JP-A-2008-184622, sedimentation of the constituent material particles cannot be suppressed and the components other than the constituent material particles cannot be sufficiently reduced while securing physical properties for manufacturing a three-dimensionally shaped object.

### SUMMARY

An object of the present disclosure is to provide a fluid composition for three-dimensional shaping in which the content of components other than constituent material particles that are metal raw materials constituting a three-dimensionally shaped object is small, which has good ejectability for manufacturing the three-dimensionally shaped object, and which is capable of suppressing sedimentation of the constituent material particles.

A fluid composition for three-dimensional shaping of an aspect of the present disclosure to achieve the object described above is a fluid composition for three-dimensional shaping used for manufacturing a three-dimensionally shaped object. The fluid composition contains constituent material particles formed from metal and constituting the three-dimensionally shaped object, and nanofiber containing at least one of chitosan nanofiber and cellulose nanofiber.

According to this aspect, the fluid composition contains constituent material particles formed from metal and nanofiber containing at least one of chitosan nanofiber and cellulose nanofiber. The inventors carried out intensive studies, and as a result, found that the fluid composition containing constituent material particles formed from metal and nanofiber containing at least one of chitosan nanofiber and cellulose nanofiber has a large degree of decrease in shear stress according to increase in shear rate (that is, has high thixotropy). Further, it has been found that only a small amount of nanofiber is needed to increase the thixotropy. That is, without increasing the other components than the constituent material particles, the constituent material particles can be made unlikely to sediment by increasing the viscosity when the fluid composition for three-dimensional shaping is left to stand (when the shear rate is low), and the ejectability can be improved by decreasing the viscosity when the fluid composition for three-dimensional shaping is ejected (when the shear rate is high).

A fluid composition for three-dimensional shaping of another aspect of the present disclosure is characterized by that, the content of the nanofiber is from 0.001% by mass to 0.003% by mass.

According to this aspect, the content of the nanofiber containing at least one of chitosan nanofiber and cellulose nanofiber is from 0.001% by mass to 0.003% by mass. As a result of intensive studies by the inventors, it has been found that, by setting the content of the nanofiber containing at least one of chitosan nanofiber and cellulose nanofiber to be from 0.001% by mass to 0.003% by mass, the thixotropy can be effectively increased, thus the ejectability for manufacturing a three-dimensionally shaped object can be effectively improved, and the sedimentation of the constituent material particles can be effectively suppressed.

A fluid composition for three-dimensional shaping of another aspect of the present disclosure is characterized by that the content of the constituent material particles is from 30% by mass to 93% by mass.

According to this aspect, the content of the constituent material particles is from 30% by mass to 93% by mass. The thixotropy can be effectively increased by setting the content of the constituent material particles to 30% by mass to 93% by mass, thus the ejectability for manufacturing a three-dimensionally shaped object can be effectively improved, and the sedimentation of the constituent material particles can be effectively suppressed.

A fluid composition for three-dimensional shaping of another aspect of the present disclosure is characterized by containing a solvent and that the solvent contains a polyol.

According to this aspect, the fluid composition contains a solvent, and the solvent contains a polyol. As a result of intensive studies by the inventors, it has been found that, by using a solvent containing a polyol, the thixotropy can be effectively increased, thus the ejectability for manufacturing a three-dimensionally shaped object can be effectively improved, and the sedimentation of the constituent material particles can be effectively suppressed.

A fluid composition for three-dimensional shaping of another aspect of the present disclosure is characterized by that the constituent material particles contain at least one of copper, aluminum oxide, stainless steel, and silicon dioxide.

According to this aspect, the constituent material particles contain at least one of copper, aluminum oxide, stainless steel, and silicon dioxide. As a result of intensive studies by the inventors, it has been found that, by using constituent material particles containing at least one of copper, aluminum oxide, stainless steel, and silicon dioxide, the thixotropy can be effectively increased, thus the ejectability for manufacturing a three-dimensionally shaped object can be effectively improved, and the sedimentation of the constituent material particles can be effectively suppressed.

A fluid composition for three-dimensional shaping of another aspect of the present disclosure is characterized by containing at least one of copper, aluminum oxide, stainless steel, and silicon dioxide as the constituent material particles, and containing cellulose nanofiber as the nanofiber.

According to this aspect, the ejectability for manufacturing a three-dimensionally shaped object can be effectively improved, and sedimentation of the constituent material particles can be effectively suppressed.

A fluid composition for three-dimensional shaping of another aspect of the present disclosure is characterized by containing at least one of copper and stainless steel as the constituent material particles, and containing chitosan nanofiber as the nanofiber.

According to this aspect, the ejectability for manufacturing a three-dimensionally shaped object can be effectively improved, and sedimentation of the constituent material particles can be effectively suppressed.

A manufacturing method for a three-dimensionally shaped object according to another aspect of the present disclosure includes forming a layer by ejecting the fluid composition for three-dimensional shaping and removing the nanofiber contained in the layer.

According to this aspect, a three-dimensionally shaped object of a high purity can be manufactured without a problem.

A three-dimensionally shaped object of another aspect of the present disclosure is formed by using the fluid composition for three-dimensional shaping.

According to this aspect, the three-dimensionally shaped object can be made to have a high purity without a problem.

### BRIEF DESCRIPTION OF THE DRAWINGS

FIG. 1 is a schematic configuration diagram illustrating an example of a configuration of a three-dimensionally shaped object manufacturing apparatus capable of using a fluid composition for three-dimensional shaping of the present disclosure.

FIG. 2 is a graph illustrating viscosity versus shear rate in an example of the fluid composition for three-dimensional shaping of the present disclosure.

FIG. 3 is a graph illustrating viscosity versus shear rate in an example of the fluid composition for three-dimensional shaping of the present disclosure.

FIG. 4 is a graph illustrating viscosity versus shear rate in an example of the fluid composition for three-dimensional shaping of the present disclosure.

FIG. 5 is a graph illustrating viscosity versus shear rate in an example of the fluid composition for three-dimensional shaping of the present disclosure.

FIG. 6 is a graph illustrating viscosity versus shear rate in an example of the fluid composition for three-dimensional shaping of the present disclosure.

FIG. 7 is a graph illustrating viscosity versus shear rate in an example of the fluid composition for three-dimensional shaping of the present disclosure.

FIG. 8 is a flowchart of a manufacturing method for a three-dimensionally shaped object according to an embodiment of the present disclosure.

### DESCRIPTION OF EXEMPLARY EMBODIMENTS

First, an example of a configuration of a three-dimensionally shaped object manufacturing apparatus capable of using a fluid composition for three-dimensional shaping of the present disclosure will be described. However, the configuration of the three-dimensionally shaped object manufacturing apparatus capable of using the fluid composition for three-dimensional shaping of the present disclosure is not limited to the following configurations.

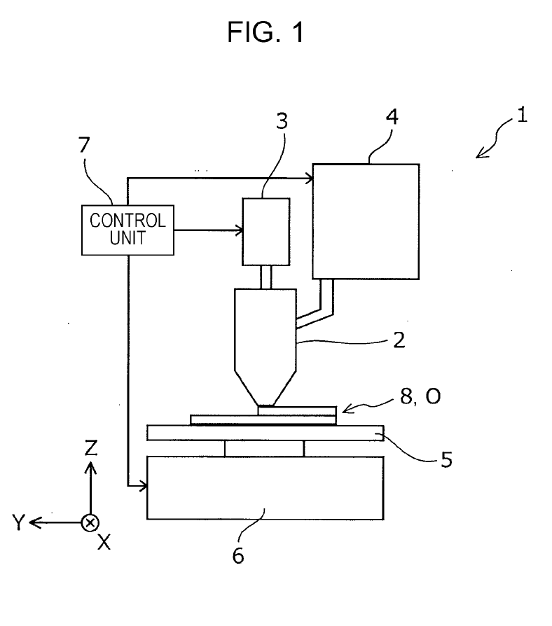

FIG. 1 is a schematic configuration diagram illustrating an example of a configuration of a three-dimensionally shaped object manufacturing apparatus 1 capable of using a fluid composition for three-dimensional shaping of the present disclosure.

To be noted, “three-dimensional shaping” used in the present description refers to forming a so-called three-dimensionally shaped object, and includes forming, for example, a flat-plate shape, or a so-called two-dimensional shape (e.g. shape constituted by one layer) having a thickness. In addition, meaning of “support” includes supporting from the side and supporting from above in some case in addition to supporting from below.

The three-dimensionally shaped object manufacturing apparatus 1 illustrated in FIG. 1 is capable of forming a three-dimensionally shaped object O by using a support layer forming material that supports a laminate of the three-dimensionally shaped object O in addition to a constituent material (fluid composition for three-dimensional shaping) of the three-dimensionally shaped object O. However, the three-dimensionally shaped object manufacturing apparatus 1 may be configured to form the three-dimensionally shaped object O without using the support layer forming material although a shape that can be formed or the like may be limited in some case.

As illustrated in FIG. 1, the three-dimensionally shaped object manufacturing apparatus 1 is capable of forming layers 8 constituting a laminate of the three-dimensionally shaped object O by using the fluid composition for three-dimensional shaping for manufacturing the three-dimensionally shaped object O containing metal. The details will be described later. The fluid composition for three-dimensional shaping contains metal powder serving as constituent material particles, and nanofiber containing at least one of chitosan nanofiber and cellulose nanofiber. However, the present disclosure is not limited to a three-dimensionally shaped object manufacturing apparatus of such a configuration.

The three-dimensionally shaped object manufacturing apparatus 1 includes a stage 5 provided so as to be capable of moving in X, Y, and Z directions in FIG. 1 or driving in a rotation direction about the Z axis. The stage 5 is connected to a stage driving unit 6 electrically connected to a control unit 7. As a result of such a configuration, the stage 5 moves under control of the control unit 7.

Here, in FIG. 1, the X direction is a horizontal direction, the Y direction is a horizontal direction perpendicular to the X direction, and the Z direction is the vertical direction.

The three-dimensionally shaped object manufacturing apparatus 1 includes an ejecting unit 2 that ejects the fluid composition for three-dimensional shaping to form the layers 8. The constituent material of the three-dimensionally shaped object O is supplied to the ejecting unit 2 from a material supplying unit 4, and the ejecting unit 2 is driven by a driving unit 3 (ejects the fluid composition for three-dimensional shaping onto the stage 5). To be noted, the material supplying unit 4 and the driving unit 3 are both electrically connected to the control unit 7, and under control of the control unit 7, the constituent material of the three-dimensionally shaped object O is supplied from the material supplying unit 4 to the ejecting unit 2, and the fluid composition for three-dimensional shaping is ejected.

To be noted, an ejecting unit that ejects a support layer forming material for forming a support layer that supports the laminate of the three-dimensionally shaped object O is also provided although the illustration thereof is omitted in FIG. 1. In addition, this ejecting unit has a similar configuration to the ejecting unit 2 that ejects the fluid composition for three-dimensional shaping. The ejecting units may eject the fluid composition for three-dimensional shaping and the support layer forming material in linear shapes or in droplet shapes. Examples of the ejecting unit 2 include screw-type extruders and plunger extruders that eject the fluid composition in a linear shape, and dispensers that eject the fluid composition in a droplet shape.

Next, the fluid composition for three-dimensional shaping of the present disclosure will be described in detail.

The fluid composition for three-dimensional shaping of the present disclosure is a fluid composition for three-dimensional shaping used for manufacturing the three-dimensionally shaped object O, and contains constituent material particles formed from metal and constituting the three-dimensionally shaped object O and nanofiber containing at least one of chitosan nanofiber and cellulose nanofiber. The inventors has carried out intensive studies, and as a result, has found that the fluid composition containing constituent material particles formed from metal and nanofiber containing at least one of chitosan nanofiber and cellulose nanofiber has a large degree of decrease in shear stress according to increase in shear rate (that is, has high thixotropy). Further, it has been found that only a small amount of nanofiber is needed to increase the thixotropy. That is, without increasing the other components than the constituent material particles, the constituent material particles can be made unlikely to sediment by increasing the viscosity when the fluid composition for three-dimensional shaping is left to stand (when the shear rate is low), and the ejectability can be improved by decreasing the viscosity when the fluid composition for three-dimensional shaping is ejected (when the shear rate is high).

To be noted, the viscosity can be obtained by dividing the shear stress by the shear rate.

### Constituent Material Particles

The fluid composition for three-dimensional shaping of the present disclosure contains constituent material particles formed from metal. Here, examples of the metal include simples of metal (e.g. copper, magnesium, iron, cobalt, titanium, chromium, nickel, and aluminum), oxides containing metal (e.g. aluminum oxide and silicon dioxide), and alloys (e.g. maraging steel, stainless steel, cobalt-chromium-molybdenum alloy, titanium alloy, nickel-based alloy, and aluminum alloy).

The content of the constituent material particles may be from 30% by mass to 93% by mass. This is because adjacent particles may sometimes be unlikely to sinter at the time of sintering of the particles when the content of the constituent material particles is lower than 30% by mass, and because the particle filling rate is too high and the fluidity becomes extremely low when the content is higher than 93% by mass. Therefore, the thixotropy can be effectively increased by setting the content of the constituent material particles to 30% by mass to 93% by mass, thus the ejectability for manufacturing a three-dimensionally shaped object can be effectively improved, and the sedimentation of the constituent material particles can be effectively suppressed.

In addition, the constituent material particles may contain at least one of copper, aluminum oxide (Al₂O₃), stainless steel (SUS), alloy of copper and nickel, and silicon dioxide (SiO₂). This is because, as a result of intensive studies by the inventors, it has been found that, by using constituent material particles containing at least one of copper, aluminum oxide, stainless steel, alloy of copper and nickel, and silicon dioxide, the thixotropy can be effectively increased, thus the ejectability for manufacturing a three-dimensionally shaped object O can be effectively improved, and the sedimentation of the constituent material particles can be effectively suppressed.

In addition, the particle diameter of the constituent material particles may be, in terms of average particle diameter (e.g. D50), from 0.5 μm to 30 μm, from 1 μm to 20 μm, or from 2 μm to 10 μm. By using metal powder for powder metallurgy of such particle diameter, the number of void holes remaining in the sintered body can be greatly reduced, and thus a sintered body having a particularly high density and excellent mechanical properties can be manufactured. To be noted, the average particle diameter is obtained as a particle diameter corresponding to a cumulative amount of 50% from the small diameter side in a mass-based cumulative particle size distribution obtained by a laser diffraction method.

In addition, when the average particle diameter of the constituent material particles is below the lower limit value described above, there is a risk that the shapeablity decreases at the time of forming a shape that is difficult to form and thus the sintered density decreases, and when the average particle diameter is above the upper limit value described above, voids between particles at the time of shaping become bigger, and thus the sintered density also decreases.

In addition, the particle size diameter of the constituent material particles may be as narrow as possible. Specifically, as long as the average particle diameter of the constituent material particles is within the range described above, the maximum particle diameter may be 200 μm or smaller, or 150 μm or smaller. By controlling the maximum particle diameter of the constituent material particles to be within the range described above, the particle size distribution of the constituent material particles can be made narrower, and thus the density of the sintered body can be further increased.

To be noted, the maximum particle diameter described above is a particle diameter corresponding to a cumulative amount of 99.9% from the small diameter side in the mass-based cumulative particle size distribution obtained by the laser diffraction method.

### Nanofiber

The fluid composition for three-dimensional shaping of the present disclosure contains nanofiber containing at least one of chitosan nanofiber and cellulose nanofiber.

The content of the nanofiber may be from 0.001% by mass to 0.003% by mass. This is because desired thixotropy may sometimes not be exhibited when the content of the nanofiber is lower than 0.001% by mass, and because the purity of the three-dimensionally shaped object O may sometimes decrease and the ejectability for manufacturing the three-dimensionally shaped object O may sometimes decrease (the viscosity may sometimes be too high) when the content of the nanofiber is higher than 0.003% by mass. That is, by setting the content of the nanofiber containing at least one of chitosan nanofiber and cellulose nanofiber to be from 0.001% by mass to 0.003% by mass, the thixotropy can be effectively increased, thus the ejectability for manufacturing a three-dimensionally shaped object O can be effectively improved, and the sedimentation of the constituent material particles can be effectively suppressed.

To be noted, although it suffices that the nanofiber contains at least one of chitosan nanofiber and cellulose nanofiber, the nanofiber may further contain another nanofiber. However, the content of the other nanofiber may be set such that the total content of the main nanofiber and the other nanofiber is 0.003% by mass or lower.

### Solvent

The fluid composition for three-dimensional shaping of the present disclosure may contain a solvent.

The content of the solvent may be from 1.5% by mass to 2.1% by mass. This is because a function of preliminarily bonding the particles together may sometimes be lost when the content of the solvent is lower than 1.5% by mass, and the purity of the three-dimensionally shaped object O may sometimes decrease and corrosion resistance and dimension stability may sometimes decrease when the content of the solvent is higher than 2.1% by mass.

In addition, polyol can be used as the solvent. This is because, as a result of intensive studies by the inventors, it has been found that, by using a solvent containing a polyol, the thixotropy can be effectively increased, thus the ejectability for manufacturing a three-dimensionally shaped object O can be effectively improved, and the sedimentation of the constituent material particles can be effectively suppressed.

Here, specific examples of the polyol include propylene glycol (PG), ethylene glycol (EG), butylene glycol, and glycerol.

Resin may be dissolved in the solvent as a viscosity modifier. However, resin that causes a polymerization reaction by, for example, increase in temperature in the ejection for manufacturing the three-dimensionally shaped object is not suitable. For example, (meth)acryloyloxyethyl phosphorylcholine copolymer and isocyanate compounds, which are used as dispersants, are not suitable as the solvent that can be contained in the fluid composition for three-dimensional shaping of the present disclosure. This is because the ejectability for manufacturing the three-dimensionally shaped object is reduced by increase in viscosity of the fluid composition for three-dimensional shaping caused by a polymerization reaction of the solvent.

### Combination of Constituent Material Particles and Nanofiber

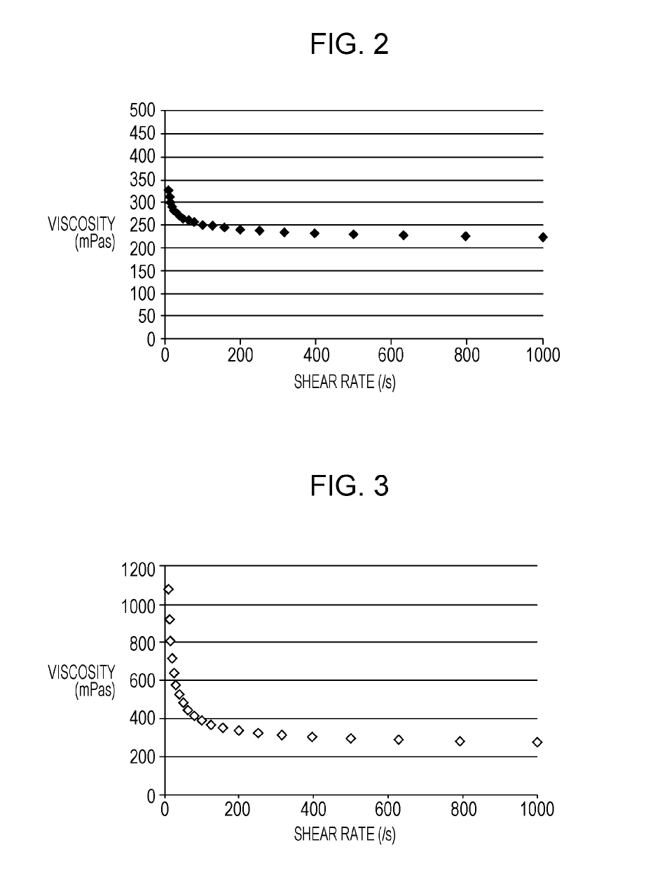

Next, examples of combinations of the constituent material particles and the nanofiber will be described with reference to FIGS. 2 to 7 illustrating graphs showing viscosity versus shear rate. When nanofiber was not added, the constituent material particles sedimented and no graph was obtained in any combination.

To be noted, a preparing procedure (composition) of the fluid composition for three-dimensional shaping used for the graphs illustrated in FIGS. 2 to 7 will be described later.

First, a case where copper powder is used as the constituent material particles will be described.

Here, FIGS. 2 and 3 are graphs showing viscosity versus shear rate in an example of the fluid composition for three-dimensional shaping in which copper powder is used as the constituent material particles. Among these, FIG. 2 is a graph of a case where chitosan nanofiber is used as the nanofiber, and FIG. 3 is a graph of a case where cellulose nanofiber is used as the nanofiber.

As shown in FIGS. 2 and 3, when copper powder is used as the constituent material particles, thixotropy (characteristic that the viscosity steeply increases when the shear rate is low as compared with when the shear rate is high) is exhibited in both cases where chitosan nanofiber is used as the nanofiber and where cellulose nanofiber is used as the nanofiber. To be noted, although the thixotropy of the case where chitosan nanofiber is used as the nanofiber is not as high as the thixotropy of the case where cellulose nanofiber is used as the nanofiber, the thixotropy is on a passing level in both cases.

Next, a case where aluminum oxide powder is used as the constituent material particles will be described.

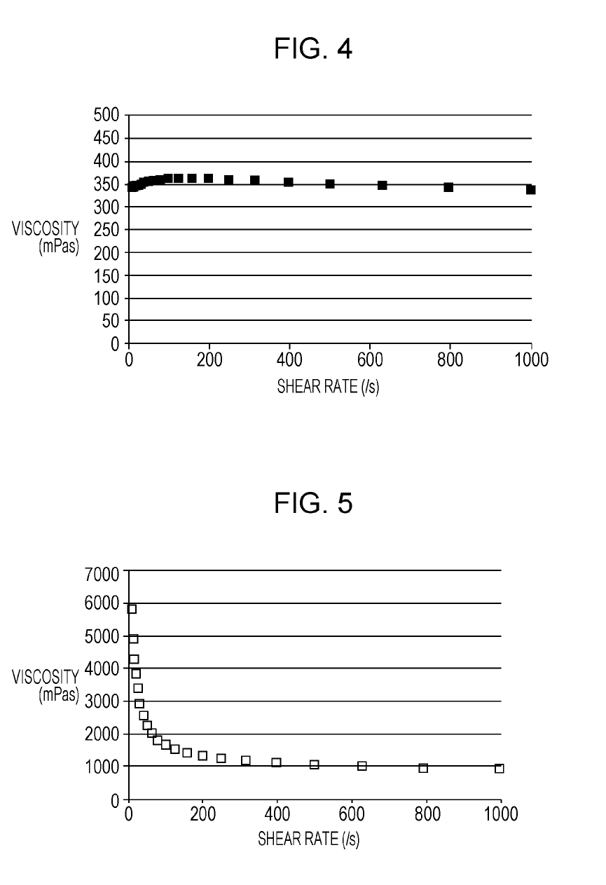

Here, FIGS. 4 and 5 are graphs showing viscosity versus shear rate in an example of the fluid composition for three-dimensional shaping when aluminum oxide powder is used as the constituent material particles. Among these, FIG. 4 is a graph of a case where chitosan nanofiber is used as the nanofiber, and FIG. 5 is a graph of a case where cellulose nanofiber is used as the nanofiber.

When aluminum oxide powder is used as the constituent material particles, as shown in FIG. 5, high thixotropy is exhibited in the case where cellulose nanofiber is used as the nanofiber. In contrast, as shown in FIG. 4, sufficient thixotropy is not sometimes exhibited when chitosan nanofiber is used as the nanofiber.

Next, a case where stainless steel powder (SUS316L, average particle diameter: 3 μm) is used as the constituent material particles will be described.

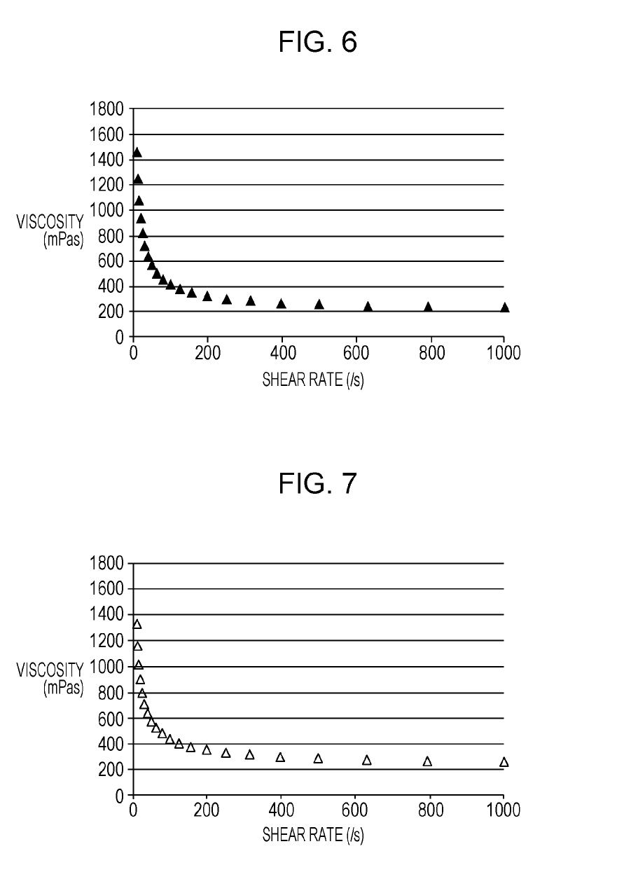

Here, FIGS. 6 and 7 are graphs showing viscosity versus shear rate in examples of the fluid composition for three-dimensional shaping when stainless steel powder is used as the constituent material particles. Among these, FIG. 6 is a graph of a case where chitosan nanofiber is used as the nanofiber, and FIG. 7 is a graph of a case where cellulose nanofiber is used as the nanofiber.

As shown in FIGS. 6 and 7, when stainless steel powder is used as the constituent material particles, high thixotropy is exhibited in both cases where chitosan nanofiber is used as the nanofiber and where cellulose nanofiber is used as the nanofiber.

To be noted, in a case where silicon dioxide powder was used as the constituent material particles, similarly to the case where aluminum oxide powder was used as the constituent material particles, although high thixotropy was exhibited when cellulose nanofiber was used as the nanofiber, sufficient thixotropy was sometimes not exhibited when chitosan nanofiber was used as the nanofiber.

As can be seen from the results shown above, when at least one of copper, aluminum oxide, stainless steel, and silicon dioxide is contained as the constituent material particles, cellulose nanofiber may be contained as the nanofiber. This is because the ejectability for manufacturing the three-dimensionally shaped object O can be effectively improved, and sedimentation of the constituent material particles can be effectively suppressed.

In addition, when at least one of copper and stainless steel is contained as the constituent material particles, chitosan nanofiber may be contained as the nanofiber. This is because the ejectability for manufacturing the three-dimensionally shaped object O can be effectively improved, and sedimentation of the constituent material particles can be effectively suppressed.

To be noted, as described above, there is a particular combination of constituent material particles and nanofiber. The reason for this is not certain, and it is presumed that this is caused by interaction between the surface of the constituent material particles and functional groups of the nanofiber (hydroxyl groups of cellulose nanofiber and amino groups of chitosan nanofiber). For example, when polyvinyl alcohol (PVA) having carboxyl groups is further contained in the solvent, it is presumed that the thixotropy of the fluid composition for three-dimensional shaping changes according to which of the nanofiber and the PVA has stronger affinity for the surface of the constituent material particles. Further, it is presumed that a fluid composition for three-dimensional shaping in which the nanofiber has stronger affinity for the surface of the constituent material particles than the PVA has higher thixotropy.

### Measurement Method

To be noted, the results of FIGS. 2 to 7 were measured by using MCR301 (rheometer) manufactured by Anton Paar and a cone plate (CP-25) of a diameter of 25 mm in a condition of a shear rate of 10 to 1000 (/s) and a strain of 0.1% in a measurement mode of flow curve measurement.

### Preparation Procedure of Fluid Composition for Three-Dimensional Shaping

To be noted, the fluid composition for three-dimensional shaping used for FIGS. 2 to 7 were prepared according to the following procedure.

First, a predetermined amount (10 g) of constituent material particles of copper, aluminum oxide, stainless steel, or the like was charged into a glass bottle.

Next, a predetermined amount (0.8 g) of a PVA solution containing 5% by mass of PVA with respect to PG was measured and charged into the glass bottle.

Next, a predetermined amount (0.8 g) of a nanofiber solution containing 0.2% by mass of a desired nanofiber (cellulose nanofiber or chitosan nanofiber) with respect to water was measured and charged into the glass bottle.

Next, a predetermined amount (0.06 g) of 2Et1HxOH (2-ethyl-1-hexanol) was charged into the glass bottle.

Next, a predetermined amount (0.004 g) of a perfect-spherical silica fine particles were measured on weighing paper, and charged into the glass bottle while paying attention such that the silica fine particles did not electrostatically attach to the inner surface of the glass bottle.

Next, the glass bottle was set in a planetary centrifugal mixer ARE310 (manufactured by THINKY CORPORATION), and mixing was performed at 1200 rpm for 5 minutes to complete the fluid composition for three-dimensional shaping. To be noted, when mixing of the substances charged into the glass bottle was insufficient even after using the planetary centrifugal mixer ARE310, the substances charged into the glass bottle were manually mixed for a certain period by using a spatula, and, if necessary, was mixed again by using the planetary centrifugal mixer ARE310.

To be noted, when it took a long time from preparing the fluid composition for three-dimensional shaping to measurement using the rheometer, the substances charged into the glass bottle were mixed again by using the planetary centrifugal mixer ARE310.

Next, an example of a manufacturing method for a three-dimensionally shaped object performed by using the fluid composition for three-dimensional shaping of the present disclosure will be described with reference to a flowchart.

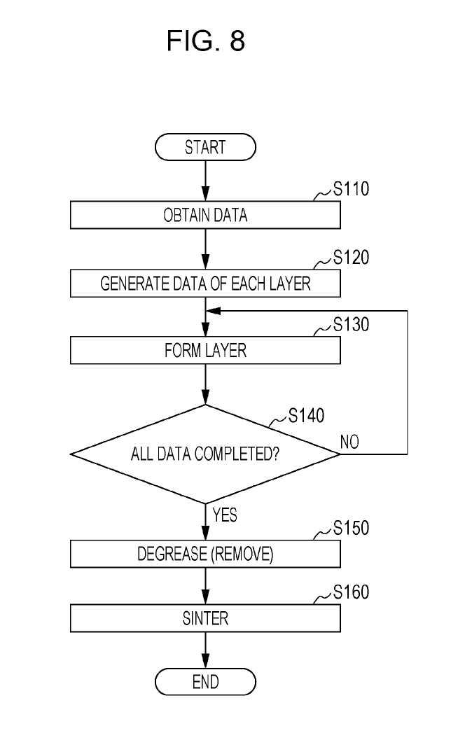

FIG. 8 is a flowchart of an example of a manufacturing method for a three-dimensionally shaped object.

As illustrated in FIG. 8, in the manufacturing method for a three-dimensionally shaped object of the present embodiment, first, data of the three-dimensionally shaped object O is obtained in step S110. Specifically, data representing the shape of the three-dimensionally shaped object O is obtained from, for example, an application program or the like executed run on a personal computer.

Next, in step S120, data of each layer is created (generated) in step S120 under control of the control unit 7. Specifically, the data representing the shape of the three-dimensionally shaped object O is sliced according to the shaping resolution in the Z direction, and bitmap data is generated for each section.

Next, in a layer forming step of step S130, under control of the control unit 7, the fluid composition for three-dimensional shaping is ejected from the ejecting unit 2 based on the bitmap data generated in step S120, and thus a layer 8 based on the bitmap data is formed.

Next, in step S140, under control of the control unit 7, it is determined whether or not formation of the layers 8 based on the bitmap data generated in step S120 is completed. The process returns to step S130 when it is determined that the formation of the layers 8 is not completed, and progresses to step S150 when it is determined that the formation of the layers 8 is completed. That is, under control of the control unit 7, step 5130 and step S140 are repeated until formation of a shaped body of the three-dimensionally shaped object O based on the bitmap data corresponding to each layer 8 generated in step S120 is finished.

Next, in a removal step of step S150, degreasing (removing the nanofiber, solvent, and the like) is executed by heating, for example, in an unillustrated thermostatic chamber, the shaped body (green body) of the three-dimensionally shaped object O formed in the steps described above. As a result of the degreasing, the green body becomes a brown body.

Then, in a sintering step of step S160, the constituent material particles in the fluid composition for three-dimensional shaping are sintered by heating, for example, in an unillustrated thermostatic chamber, the brown body of the three-dimensionally shaped object O formed in the steps described above.

Then, according to the completion of step S180, the manufacturing method for a three-dimensionally shaped object of the present embodiment is finished.

As described above, the manufacturing method for a three-dimensionally shaped object of the present embodiment includes forming a layer 8 by ejecting the fluid composition for three-dimensional shaping (step S130), and removing the nanofiber and the like contained in the layer 8 (step S150). By performing the manufacturing method for a three-dimensionally shaped object of the present embodiment, the three-dimensionally shaped object O of high purity can be manufactured without a problem.

In addition, expressing the present disclosure from the viewpoint of a three-dimensionally shaped object, the three-dimensionally shaped object O formed by using the fluid composition for three-dimensional shaping of the present disclosure described above is a three-dimensionally shaped object of high purity without a problem.

The present disclosure is not limited to the examples described above, and can be realized by various configuration within the gist thereof. For example, technical features in the examples corresponding to technical features of aspects described in the summary can be appropriately replaced and combined to solve part or all of technical problems described above or achieve part or all of effects described above. In addition, technical features not described as necessary in the present description can be appropriately deleted.

What is claimed is:

1. A fluid composition for three-dimensional shaping used for manufacturing a three-dimensionally shaped object, the fluid composition comprising:
constituent material particles formed from metal and constituting the three-dimensionally shaped object; and
nanofiber containing at least one of chitosan nanofiber and cellulose nanofiber.

2. The fluid composition for three-dimensional shaping according to claim 1, wherein a content of the nanofiber is from 0.001% by mass to 0.003% by mass.

3. The fluid composition for three-dimensional shaping according to claim 1, wherein the content of the constituent material particles is from 30% by mass to 93% by mass.

4. The fluid composition for three-dimensional shaping according to claim 1, the fluid composition further comprising a solvent, wherein the solvent contains a polyol.

5. The fluid composition for three-dimensional shaping according to claim 1, wherein the constituent material particles contain at least one of copper, aluminum oxide, stainless steel, and silicon dioxide.

6. The fluid composition for three-dimensional shaping according to claim 5, wherein the fluid composition contains at least one of copper, aluminum oxide, stainless steel, and silicon dioxide as the constituent material particles, and contains cellulose nanofiber as the nanofiber.

7. The fluid composition for three-dimensional shaping according to claim 5, wherein the fluid composition contains at least one of copper and stainless steel as the constituent material particles, and contains chitosan nanofiber as the nanofiber.

8. A manufacturing method for a three-dimensionally shaped object, the manufacturing method comprising:
forming a layer by ejecting the fluid composition for three-dimensional shaping according to claim 1; and
removing the nanofiber contained in the layer.

9. A three-dimensionally shaped object formed by using the fluid composition for three-dimensional shaping according to claim 1.
